(19) United States
(12) Patent Application Publication
(10) Pub. No.: US 2009/0087065 A1
(43) Pub. Date: Apr. 2, 2009

(54) ACCOUNTING FOR FOREIGN OBJECTS WHEN CREATING CT-BASED ATTENUATION MAPS

(75) Inventors: Angela J. DaSilva, Danville, CA (US); Lingxiong Shao, Saratoga, CA (US)

Correspondence Address: PHILIPS INTELLECTUAL PROPERTY & STANDARDS, 595 MINER ROAD, CLEVELAND, OH, 44143, US

(73) Assignee: KONINKLIJKE PHILIPS ELECTRONICS N. V., Eindhoven (NL)

(21) Appl. No.: 12/278,001

(22) PCT Filed: Jan. 29, 2007
(86) PCT No.: PCT/US2007/061194

§ 371 Date: Aug. 1, 2008

Related U.S. Application Data
(60) Provisional application No. 60/765,450, filed on Feb. 3, 2006.

(51) Int. Cl. G06K 9/00

(52) U.S. Cl. 382/131

(57) ABSTRACT

In a method for generating an attenuation map (30), image elements of a reconstructed tomographic image (24) are segmented into at least first, second, and third classes (50, 52, 54). Each image element of the first class (50) is transformed using a first image element value-dependent attenuation transform (60). Each image element of the second class (52) is transformed using a second image element value-dependent attenuation transform (62) different from the first image element value-dependent attenuation transform. Each image element of the third class (54) is transformed using a third image element value-dependent attenuation transform (64) different from both the first and second image element value-dependent attenuation transforms.

The following relates to the imaging arts. It finds particular application in generating attenuation maps based on an image from one modality, such as computed tomography (CT) imaging, for use in subsequent nuclear-based imaging, such as single-photon emission computed tomography (SPECT) imaging, positron-electron tomography (PET) imaging, and so forth, and will be described with particular reference thereto. However, it finds more general application in generating attenuation maps based on computed tomography (CT) imaging for other applications, such as for radiation therapy planning.

In SPECT imaging, PET imaging, or other types of imaging employing administered radiopharmaceuticals, attenuation of emitted radiation as it passes through the imaged subject is preferably accounted for during image reconstruction. Toward this end, an attenuation map of the imaging subject is advantageously provided. An attenuation map can be estimated based on measurements of attenuation in a phantom, or based on first principles calculation. However, such estimated attenuation maps can introduce errors into the image reconstruction.

A more accurate attenuation map of the imaging subject can be generated based on CT imaging data acquired from the imaging subject. Such CT imaging data may be acquired using a radiation source arranged to transmit radiation such as x-rays generated by an x-ray tube, radiation generated by a Gd-153 line source, or so forth, through the subject. The CT image produced by transmission CT projection data is indicative of absorption of radiation passing through (that is, transmitted through) the imaging subject. Such radiation absorption is qualitatively similar to absorption of gamma rays emitted by radiopharmaceuticals. For example, both x-rays and gamma rays are more strongly absorbed by bone as compared with softer tissue. Accordingly, CT imaging data can be used to estimate an attenuation map for gamma rays emitted by the radiopharmaceutical. Typically, a scaling factor is used to convert CT pixel values in Hounsfield units to linear attenuation coefficients (LAC) at the appropriate energy of gamma rays emitted by the radiopharmaceutical. In a bilinear scaling approach, pixels values above a certain threshold are scaled using a “bone” scaling factor, while pixel values below this threshold are scaled using a “tissue” scaling factor. The appropriate scaling factor in each of these regions is measured or calculated based on assumed physical absorption properties.

A problem arises when the imaging subject contains foreign elements other than bone and tissue. Such foreign elements may include, for example, metal implants, contrast agent administered for contrast-enhanced imaging, synthetic implants, or so forth. To account for such foreign elements, the bilinear scaling approach is sometimes modified by fixing the absorption map pixel values corresponding to CT pixel values at or above the bone threshold to a fixed attenuation value.

The inventors have found that employing such fixed values in generating the attenuation map from CT data leads to errors in reconstruction of the SPECT, PET, or other radioemission-based imaging data. The fixed values are typically not well-representative of the gamma ray absorption by foreign objects. Employing fixed attenuation values for foreign elements may fail to reflect gradations of attenuation within the foreign object, and may introduce artificially abrupt attenuation transitions at the borders or edges of the foreign object. These artificial features in the attenuation map translate into image artifacts in the reconstructed SPECT, PET, or other radioemission-based image.

According to one aspect, a method is disclosed for generating an attenuation map. Image elements of a reconstructed tomographic image are segmented into at least first, second, and third classes. Each image element of the first class is transformed using a first image element value-dependent attenuation transform. Each image element of the second class is transformed using a second image element value-dependent attenuation transform different from the first image element value-dependent attenuation transform. Each image element of the third class is transformed using a third image element value-dependent attenuation transform different from both the first and second image element value-dependent attenuation transforms.

According to another aspect, an imaging method is disclosed. An attenuation map is generated using a method as set forth in the first paragraph of this summary. Acquired single photon emission computed tomography (SPECT) or positron-emission tomography (PET) image data are reconstructed into a SPECT or PET image using the attenuation map.

According to another aspect, a radiation therapy method is disclosed. An attenuation map is generated using a method as set forth in the first paragraph of this summary. A radiation therapy session is planned using the attenuation map.

According to another aspect, an attenuation map generator is disclosed for processing a reconstructed tomographic image to generate an attenuation map. A table-based attenuation transform includes a look-up table containing entries for transforming values of image elements of the reconstructed tomographic image to attenuation values.

According to another aspect, a look-up table is disclosed, which is preprogramnmed with attenuation coefficients providing an image element value-dependent attenuation transform corresponding to a material or object type other than tissue and bone, the look-up table configured for use in an attenuation map generating method operable on a tomographic image.

One advantage resides in generating more accurate attenuation maps.

Another advantage resides in more accurate SPECT, PET, or other radioemission-based imaging data reconstruction.

Another advantage resides in reduced image artifacts.

Numerous additional advantages and benefits will become apparent to those of ordinary skill in the art upon reading the following detailed description of the preferred embodiments.

The invention may take form in various components and arrangements of components, and in various process operations and arrangements of process operations. The drawings are only for the purpose of illustrating preferred embodiments and are not to be construed as limiting the invention.

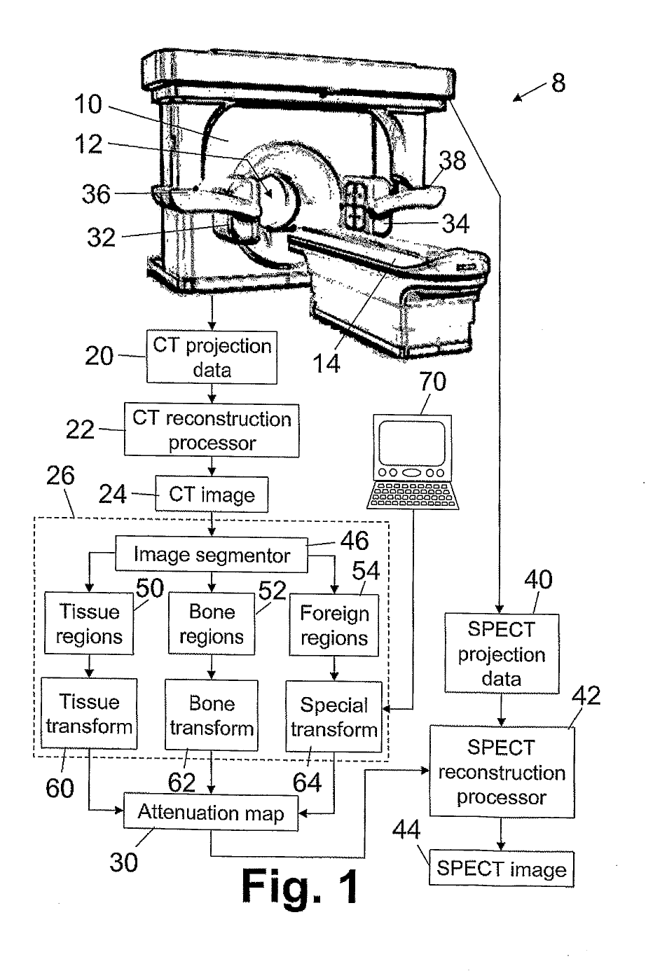

FIG. 1 shows an example combined SPECT/CT imaging system that is convenient for performing SPECT imaging including attenuation correction based on an attenuation map generated from a CT image. FIG. 1 shows imaging data processing components diagrammatically.

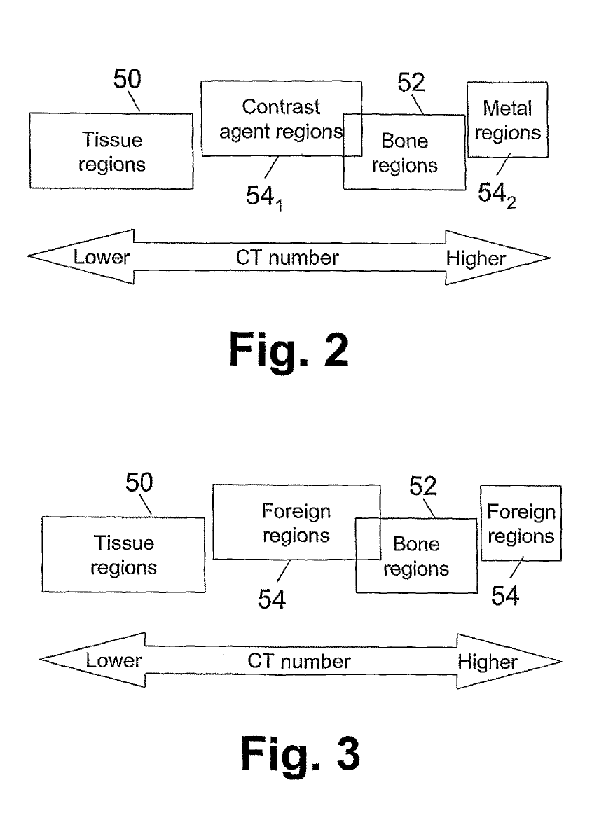

FIG. 2 shows a suitable segmentation approach in which the segmentation segments foreign regions into two different classes, one for contrast agent and another for metal implants.

FIG. 3 shows another suitable segmentation approach in which the segmentation segments as foreign regions any region that is neither tissue nor bone, without distinguishing what foreign element the foreign region corresponds to.

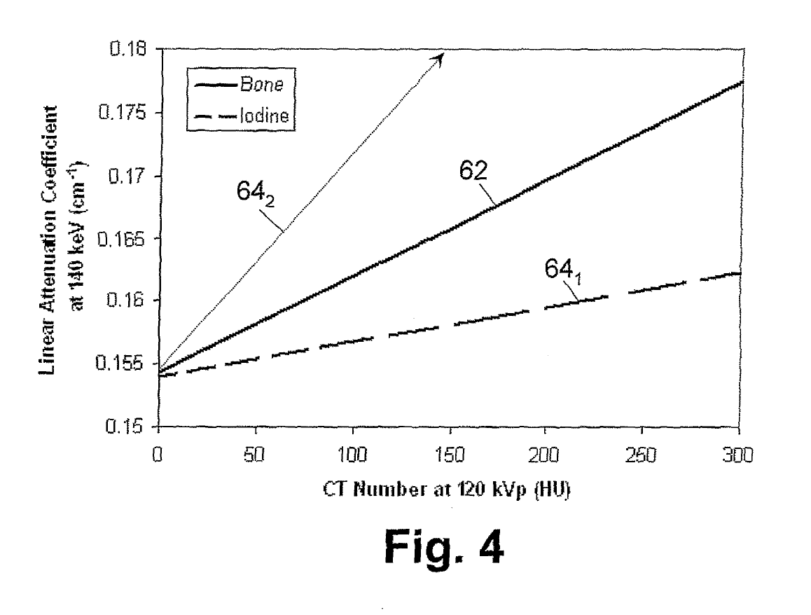

FIG. 4 plots estimated linear attenuation coefficient (LAC) for gamma rays at 140 keV as a function of CT image element value in Hounsfield units for bone, for an iodine-based contrast agent, and for a metal implants region.

With reference to FIG. 1, a combined single photon emission computed tomography/transmission computed tomography (SPECT/CT) imaging system 8 provides both CT and SPECT imaging capability. The illustrated example SPECT/CT imaging system 8 is a Precedence™, SPECT/CT system (available from Philips Medical Systems, having a U.S. office in Milpitas, Calif.).

The CT scanner includes a transmission CT gantry housing 10 having a bore 12. An imaging subject is disposed on a support 14 and is moved into the bore 12. The CT gantry housing 10 defines the bore 12 and encloses elements (not shown) including an x-ray tube and an x-ray detector array mounted in opposing fashion on a rotating gantry. As the gantry rotates, the x-ray tube and x-ray detector array revolve in concert around the imaging subject in the bore 12 to acquire CT projection data spanning a full 360° revolution or spanning a smaller arc, or spanning multiple revolutions, or so forth. In some CT imaging sequences, the imaging subject support 14 remains stationary during imaging data acquisition to generate imaging data over one or more parallel slices defined by the geometry of the x-ray tube and x-ray detector array and corresponding to detector array rows. For example, some SPECT/CT systems include a six-slice CT scanner, while some other SPECT/CT systems include a sixteen-slice CT scanner. Additional slices are optionally acquired by moving the subject support 14 between scans to reposition the imaging subject further along in the bore 12, and acquiring CT imaging data for additional slices with the imaging subject thusly repositioned. In other CT imaging sequences, the imaging subject support 14 moves continuously in a direction transverse to the plane of gantry rotation during imaging data acquisition to acquire helical computed tomography imaging data. The acquired CT imaging data is CT projection data 20—each projection indicates x-ray attenuation along a linear path between the x-ray tube and a position of an x-ray detector array element during the gantry rotation. A CT reconstruction processor 22 reconstructs the CT projection data 20 using filtered backprojection, a Fourier transform-based reconstruction, or another reconstruction algorithm to generate a CT image 24 made up of image elements such as pixels (for a two-dimensional image or plurality of two-dimensional image slices) or voxels (for a three-dimensional image). In some embodiments, the CT image 24 has image element values in Hounsfield units (HU) given by (see, e.g., Kinahan et al., “X-ray-Based Attenuation Correction for Positron Emission Tomography/Computed Tomography Scanners”, Seminars in Nuclear Medicine Vol. XXXIII, No. 3 (July 2003)):

$$HU ( r ) = 1000 ( \frac{μ ( r )}{{μ}_{water}} - 1 ) , \qquad ( 1 )$$

where μ(r) denotes the attenuation value at image element r, which is in general a function of x-ray photon energy, μ_{water} is the attenuation value for an image element corresponding to water, and HU(r) is the Hounsfield unit value (also called the “CT number”) at image element r. Note that the CT number for water by definition equals zero. Typically, air, vacuum, or other radiation-transparent media have a CT number of about −1000 (that is, μ(air)≈0), while adipose tissue has a CT number of about −100. The CT number for bone depends upon its density—for example, relatively low density trabecular bone has a CT number of about 100 to 300, whereas relatively high density cortical bone has a CT number of about 1000 to 2000. Although the Hounsfield unit or CT number is a conventional representation commonly used for CT images, it is contemplated to use another representation in the CT image 24. The CT image 24 is processed by an attenuation map generating processor 26 to produce an attenuation map 30.

The SPECT/CT imaging system 8 further provides gamma camera capability using two radiation detector heads 32, 34 supported by respective robotic arms 36, 38. The robotic arms 36, 38 enable the detector heads 32, 34 to be moved around the imaging subject disposed on the subject support 14 to acquire views of the imaging subject spanning 180°, 270°, or another selected angular arc. The detector heads 32, 34 include collimators such that each detected radiation event is known to have originated along an identifiable linear or narrow-angle projection path, so that the acquired SPECT data is in the form of SPECT projection data 40. A SPECT reconstruction processor 42 reconstructs the SPECT projection data 40 using filtered backprojection, an iterative reconstruction algorithm, a Fourier transform-based reconstruction algorithm, or another reconstruction algorithm to generate a SPECT image 44 made up of image elements such as pixels (for a two-dimensional image slice or parallel array of two-dimensional image slices) or voxels (for a three-dimensional image).

The illustrated CT scanner employs an x-ray tube to generate x-rays for transmission through the subject. In other embodiments, other types of radiation sources may be used to generate radiation for transmission to generate the CT image 24 from which the attenuation map 30 is generated. For example, the CT image can be acquired using one or more of the detector heads of the gamma camera operating in conjunction with a radioisotope source, such as a Gd-153 line source, positioned to transmit radiation through the subject to the detector head. By rotating the detector head and the transmission radioisotope source, CT projection data is acquired over a range of angles enabling CT image reconstruction.

The SPECT reconstruction processor 42 uses the attenuation map 30 generated from the CT image 24 to account for attenuation of gamma rays, and optionally to account for scattering or other secondary effects of the imaging subject. Accordingly, the SPECT imaging data 40 are suitably acquired from the same region of the imaging subject as the CT imaging data 20. As the CT and SPECT scanner portions of the imaging system 8 are spatially offset, this is suitably accomplished by moving the subject support 14 to reposition the imaging subject between the CT and SPECT scans.

In order to use the attenuation map 30 in the SPECT reconstruction, the attenuation map 30 (or the underlying CT image 24) is spatially registered with the SPECT or PET imaging data using fiducial markers disposed on or implanted in the imaging subject, or using intrinsic registration markers such as distinctive elements of the organ or other anatomical feature of interest, or based on prior knowledge of the offset between the SPECT and CT imaging regions. In some embodiments, Syntegra Image Fusion™ software (available from Philips Medical Systems, having a U.S. office in Milpitas, Calif.) is used to register the attenuation map 30 (or the underlying CT image 24) with the SPECT image 44.

The SPECT/CT imaging system 8 is an illustrative example. In other embodiments, a positron/electron tomography/transmission computed tomography (PET/CT) imaging system is employed, with PET imaging data reconstruction employing the attenuation map generated by CT imaging. An example of a PET/CT imaging system is the Gemini™ PET/CT imaging system (available from Philips Medical Systems, having a U.S. office in Milpitas, Calif.). Moreover, the apparatuses, and methods disclosed herein are not limited to combined systems in which a nuclear imaging system is combined with a CT imaging system. In some embodiments, for example, the CT image may be acquired using a stand-alone CT imaging system, and the SPECT, PET, or other nuclear imaging data may be acquired using a separate stand-alone SPECT or PET imaging system.

The attenuation map 30 generated from the CT image data can be used for other purposes besides accounting for absorption or other secondary effects in reconstructing nuclear imaging data. For example, the attenuation map 30 may be used for planning a radiation therapy session. For application in radiation therapy, the CT scanner may be integrated with the radiation therapy apparatus (similar to the illustrated combined SPECT/CT 8, but replacing the SPECT scanner portion with a radiation therapy delivery system portion), or the CT scanner can be a stand-alone unit and registration of the CT-based attenuation map with the radiation therapy system achieved using extrinsic or intrinsic fiducial markers.

Having described some example applications of the CT-based attenuation map 30, the illustrated example attenuation map generating processor 26 is described in greater detail.

An image segmentation processing step or segmentor 46 segments the CT image 24 into regions based on image element value, region connectivity, or other segmentation bases. Substantially any type of image segmentation algorithm can be used, such as a region growth technique, a deformable surface fitting technique, or so forth. In some embodiments, the image segmentor 46 is implemented using region-of-interest (ROI) identification tools to perform the segmentation task. The image segmentor 46 classifies image elements of the CT image 24 into one of three or more classes: (i) regions of tissue class 50; (ii) regions of bone class 52; and (iii) regions of foreign element class 54.

With brief reference to FIG. 2, although a single classification of foreign regions 54 is shown in example FIG. 1, it is to be appreciated that there may be two or more different classes of foreign regions. For example, image elements of a metal implants region 54₂ may have higher CT numbers than those of the bone regions 52; whereas, image elements of a contrast agent region 54₁ may have an CT number intermediate between the average CT number of the tissue regions 50 and the average CT number of bone regions 52. Thus, in this example the image segmentor 46 suitably segments the image with reference to a contrast agent foreign regions class 54₁ (for example, having a CT number range above that of tissue and below and slightly overlapping that of bone) and a metal foreign regions class 54₂ (for example, having a CT number range greater than that of bone).

With brief reference to FIG. 3, in another approach, a single class of foreign regions 54 is segmented, which optionally includes more than one CT number range. For example, as shown in FIG. 3, the single class of foreign regions 54 include a first CT number range above the CT number range of tissue and below and slightly overlapping the CT number range of bone, and a second CT number range above the CT number range of bone. The segmentation in this approach segments as foreign regions 54 any region that belongs to neither the tissue regions 50 nor the bone regions 52, without distinguishing what type of foreign element each foreign region corresponds to. One suitable approach for segmenting as diagrammatically illustrated in FIG. 3 is as follows: (i) first segment the bones regions 52 from the CT image 24; (ii) once the bones regions 52 have been identified and removed, all remaining image elements having values above a selected threshold are identified as foreign object regions 54. Since the general skeletal structure is well known, the initial bone segmentation is optionally performed using an anatomical model-based segmentation technique.

In some embodiments, a model-based segmentation technique is contemplated to segment the foreign object image elements directly using a priori knowledge about the distribution of the foreign object image elements, such as using an anatomical model of the gastrointestinal (GI) tract for segmenting oral contrast regions, or using an anatomical model of a artificial hip for segmenting a hip implant.

With reference to FIG. 1, the image elements of the tissue regions 50 are transformed by a first value-dependent attenuation transform 60 suitable for the tissue regions 50. The first value-dependent attenuation transform 60 outputs estimated gamma ray attenuation values corresponding to the CT numbers of the tissue regions 50. Similarly, the image elements of the bone regions 52 are transformed by a second value-dependent attenuation transform 62 suitable for the bone regions 52. The second value-dependent attenuation transform 62 outputs estimated gamma ray attenuation values corresponding to the CT numbers of the bone regions 52. The image elements of the foreign regions 54 are similarly transformed by a value-dependent attenuation transform 64, although the selected approach depends upon how the foreign regions 54 are segmented. The transformed image elements define the attenuation map 30.

With reference to FIGS. 1 and 2, if the foreign regions 54 are segmented into different classes 54₁, 54₂, then each class 54₁, 54₂ is suitably transformed by its own value-dependent attenuation transform 64₁, 64₂ (see FIG. 4).

With reference to FIGS. 1 and 3, if the segmentation identifies a single class of foreign regions 54 that are neither tissue nor bone, then the image element value-dependent attenuation transform 64 is suitably a selectable linear attenuation coefficient transform characteristic of each selected foreign element type. The foreign element type corresponding to each foreign region is suitably selected based on a shape or density of the region. For example, a network of tubular foreign regions of relatively low density (such as having CT numbers less than or slightly overlapping the lower end of the bone CT number region) is likely to correspond to vascular contrast agent foreign element type; whereas a compact region of image elements having CT numbers above the bone CT number range is likely to be a metal implant foreign element type. Alternatively or additionally, the selection of the foreign element type for each of the foreign regions 54 can be received from a radiologist or other user via a user interface 70. Once the foreign element type is selected, a corresponding value-dependent attenuation transform is applied for the image elements in the foreign region corresponding to the identified foreign element type.

Optionally, an additional region corresponding to air can be segmented. Typically, the air region is suitably modeled using either the same image element value-dependent attenuation transforms 60 as for tissue, or using an image element value-independent constant attenuation value of zero or some small number (that is, air is modeled as producing essentially no attenuation).

In some embodiments, the value-dependent attenuation transforms 60, 62, 64 are suitably linear attenuation coefficient (LAC) transforms. Tissue and bone LAC transforms used in existing bilinear attenuation map scaling are suitably applied for the tissue LAC transform 60 and the bone LAC transform 62, respectively. The LAC transform 64 for each type of foreign element (such as contrast agent, metal implant, or so forth) is suitably determined experimentally, or based on first principles computation based on the material of the foreign element.

With reference to FIG. 3 and with further reference to FIG. 4, an experimentally obtained bone LAC transform 62 is plotted in FIG. 4 along with an experimentally obtained iodine LAC transform 64₁, Both LAC transforms 62, 64₁ are for 140 keV gamma rays corresponding to the peak energy emission of the Tc-99m radioisotope, and are plotted against CT number acquired using 120 kVp x-rays. As a specific example, for a bone region image element having a CT number of 150 HU, the linear attenuation value given by the bone LAC transform 62 is 0.166/cm. For an iodine contrast agent region image element having the same CT number of 150 HU, the linear attenuation value given by the contrast agent LAC transform 64₁ is lower, at 0.158/cm. It will be noted that for the same CT number, different attenuation values are obtained for the bone and iodine regions. In FIG. 4, an estimated LAC transform 64₂ for the metal implants region 54₂ of FIG. 2 is also illustrated. Because of metal's high density, metal regions are expected to have substantially higher attenuation than bone.

When using the segmentation approach of FIG. 3, the example LAC transforms 62, 64₁, 64₂ of FIG. 4 remain suitable—however, for each foreign region 64, the appropriate one of the two LAC transforms 64₁, 64₂ is selected by a selection of the foreign element type received via the user interface 70, or by determination of the foreign element type based on the shape and/or density of the foreign region.

Although LAC transforms are illustrated, it is to be appreciated that more complex transforms can be used. For example, quadratic image element value-dependent attenuation transforms incorporating bowing parameters to model non-linearities can be used.

In another embodiment, the image from which the attenuation map is generated are acquired by one or more imaging modalities which may or may not include CT. Based on properties of the image pixels, shapes of segmented regions, a priori information, operator input, and the like, the material in each segmented region is identified, e.g. metal, ceramics, artificial cartilage, contrast agent, bone, air, soft tissue, and the like. Optionally, the materials may be yet more accurately identified, e.g. the metal can be identified as surgical steel, amalgam fillings, etc., the soft tissue can be identified as cartilage, muscle, blood, liver, etc.

In some embodiments, the identified material and the energy of the radiopharmaceutical can be input into a pre-programmed look-up table look-up table to retrieve the corresponding value or attenuation transform to generate the attenuation map. That is, the value-dependent attenuation transform 64 may include a look-up table, and a characteristic of a segmented region of the third class 54 used to identify an entry of the look-up table providing the attenuation transform. The look-up table can be material-based, listing for example certain types of plastics or metals commonly used for implants, types of chemicals commonly used for contrast agents, or so forth, along with corresponding attenuation values. Additionally or alternatively, the look-up table can be based on foreign object type, listing for example general implant type such as hip implant, knee implant, screw implant, or so forth, or listing more specific foreign object identifications, such as a part number of the particular hip implant, or so forth. If the foreign object type includes more than one material (for example, an implant with both ceramic and metal components), then the look-up table may include different attenuation values for the regions of different material within the foreign object.

Information for employing the look-up table, such as identification of the material or foreign object type, is optionally provided by user input through the user interface 70. In other embodiments, the segmented region shape, average CT number, or other characteristic is automatically measured and compared to the look-up table entries so as to automatically select the material, foreign object type, or so forth. In some embodiments, such automated measurement is used to provide the user with a choice of the closest options to choose from via the user interface 70. In some embodiments, once the object is identified, this identifying information is used in refining the segmentation to provide improved contouring of the segments.

The invention has been described with reference to the preferred embodiments. Obviously, modifications and alterations will occur to others upon reading and understanding the preceding detailed description. It is intended that the invention be construed as including all such modifications and alterations insofar as they come within the scope of the appended claims or the equivalents thereof.

1. A method for generating an attenuation map, the method comprising:
segmenting image elements of a reconstructed tomographic image into at least first, second, and third classes;
transforming each image element of the first class using a first image element value-dependent attenuation transform;
transforming each image element of the second class using a second image element value-dependent attenuation transform different from the first image element value-dependent attenuation transform; and
transforming each image element of the third class using a third image element value-dependent attenuation transform different from both the first and second image element value-dependent attenuation transforms.

2. The method as set forth in claim 1, wherein the image elements are one of (i) voxels, the tomographic image being a three-dimensional tomographic image, and (ii) pixels, the tomographic image being a two-dimensional tomographic image or a set of parallel two-dimensional tomographic image slices.

3. The method as set forth in claim 1, wherein image elements of the first class correspond to tissue and image elements of the second class correspond to bone, the image elements of the tissue class having lower values than image elements of the bone class.

4. The method as set forth in claim 3, wherein (i) the first image element value-dependent attenuation transform is a linear attenuation coefficient transform characteristic of tissue and (ii) the second image element value-dependent attenuation transform is a linear attenuation coefficient transform characteristic of bone.

5. The method as set forth in claim 4, wherein the third image element value-dependent attenuation transform is a linear attenuation coefficient transform characteristic of a foreign element.

6. The method as set forth in claim 5, wherein the segmenting further segments image elements of the tomographic image into a fourth class, the method further comprising:
transforming each image element of the fourth class using a fourth image element value-dependent linear attenuation coefficient transform characteristic of a second foreign element.

7. The method as set forth in claim 6, wherein the foreign element class corresponds to a contrast agent foreign element type and the second foreign element class corresponds to a metal implant foreign element type.

8. The method as set forth in claim 4, wherein the third image element value-dependent attenuation transform is a selectable linear attenuation coefficient transform characteristic of an identified foreign element type.

9. The method as set forth in claim 8, further including at least one of:
identifying the foreign element type for a segmented region of image elements of the third class based on a shape or density of the region;
receiving the selection of the foreign element type for a segmented region of image elements of the third class via a user interface; and
selecting the foreign element type for a segmented region of image elements of the third class based on a characteristic of the image elements of the segmented region.

10. The method as set forth in claim 1, wherein the first image element value-dependent attenuation transform is a first linear attenuation coefficient transform, the second image element value-dependent attenuation transform is a second linear attenuation coefficient transform, and the third image element value-dependent attenuation transform is a third linear attenuation coefficient transform.

11. The method as set forth in claim 10, wherein the third linear attenuation coefficient transform is a selectable linear attenuation coefficient transform characteristic of a selected foreign element type.

12. The method as set forth in claim 1, further including:
acquiring computed tomography projection data; and
reconstructing the computed tomography projection data to generate the reconstructed tomographic image.

13. The method as set forth in claim 1, wherein the third image element value-dependent attenuation transform includes a look-up table.

14. An imaging method comprising:
generating an attenuation map using a method as set forth in claim 1; and
reconstructing acquired single photon emission computed tomography (SPECT) or positron-emission tomography (PET) image data into a SPECT or PET image using the attenuation map.

15. The imaging method as set forth in claim 14, further comprising:
acquiring computed tomography projection data using the CT portion of an integrated SPECT/CT or PET/CT imaging system;
reconstructing the computed tomography projection data to generate the reconstructed tomographic image; and
acquiring the SPECT or PET data using the integrated SPECT/CT or PET/CT imaging system.

16. A radiation therapy method comprising:
generating an attenuation map using a method as set forth in claim 1; and
planning a radiation therapy session using the attenuation map.

17. A processor which performs a method as set forth in claim 1.

18. Computer software for programming one or more processors to perform the method set forth in claim 1.

19. An imaging system comprising:
a single photon emission computed tomography (SPECT) or positron-emission tomography (PET) scanner;
a tomographic scanner;
an attenuation map generating processor which generates an attenuation map in accordance with the method as set forth in claim 1 using a tomographic image acquired using the tomographic scanner; and
a reconstruction processor for reconstructing SPECT or PET imaging data acquired using the SPECT or PET scanner using the attenuation map generated by the attenuation map generating processor.

20. The imaging system as set forth in claim 19, wherein the tomographic scanner includes a CT scanner integrated with the SPECT or PET scanner.

21. A look-up table preprogrammed with attenuation coefficients providing an image element value-dependent attenuation transform corresponding to a material or object type other than tissue and bones the look-up table configured for use in an attenuation map generating method operable on a tomographic image.

22. The look-up table as set forth in claim 21, wherein the look-up table is further preprogrammed with attenuation coefficients providing an image element value-dependent tissue attenuation transform and an image element value-dependent bone attenuation transform.

23. An imaging system comprising:
means for segmenting image elements of a reconstructed tomographic image into at least first, second, and third classes;
means for transforming each image element of the first class using a first image element value-dependent attenuation transform;
means for transforming each image element of the second class using a second image element value-dependent attenuation transform different from the first image element value-dependent attenuation transform; and
means for transforming each image element of the third class using a third image element value-dependent attenuation transform different from both the first and second image element value-dependent attenuation transforms.

24. An attenuation map generator for processing a reconstructed tomographic image to generate an attenuation map, the attenuation map generator comprising:
a table-based attenuation transform including a look-up table containing entries for transforming values of image elements of the reconstructed tomographic image to attenuation values.

25. The attenuation map generator as set forth in claim 24, further including:
an image segmentor for segmenting image elements of the reconstructed tomographic image into at least first, second, and third classes, the table-based attenuation transform being used to transform values of image elements of the third class to attenuation values;
a first image element value-dependent attenuation transform for transforming values of image elements of the first class to attenuation values; and
a second image element value-dependent attenuation transform for transforming values of image elements of the second class to attenuation values.

26. The attenuation map generator as set forth in claim 25, wherein the table-based attenuation transform automatically measures a characteristic of a segmented region of the third class, one or more entries of the look-up table used for transforming image elements of the segmented region being selected based on the automatically measured characteristic.

27. The attenuation map generator as set forth in claim 26, wherein the image segmentor refines the segmentation of segmented regions of the third class based on the automatically measured characteristic.

28. The attenuation map generator as set forth in claim 25, further including:
a user interface for receiving a user selection corresponding to a segmented region of the third class, the table-based attenuation transform selecting one or more entries of the took-up table for transforming image elements of the segmented region based on the received user selection.

29. The attenuation map generator as set forth in claim 24, wherein the look-up table entries relate at least one of (i) material type and (ii) foreign object type with corresponding attenuation values.
